(19) United States
(12) Patent Application Publication
(10) Pub. No.: US 2019/0027018 A1
(43) Pub. Date: Jan. 24, 2019

(54) ARTIFICIAL INTELLIGENCE BASED SERVICE CONTROL AND HOME MONITORING

(71) Applicant: ACCENTURE GLOBAL SOLUTIONS LIMITED, Dublin 4 (IE)

(72) Inventors: Roy C. Corpus, Manila (PH); Benjamin D. Delos Santos, JR., Mandaluyong City (PH); Richard R. Carreon, Binan City (PH); Jose Luis O. Domingo, Binan City (PH); Jeremai D. Romantigue, Binan City (PH); Mark Joseph D. Florendo, Taytay (PH)

(73) Assignee: ACCENTURE GLOBAL SOLUTIONS LIMITED, Dublin 4 (IE)

(21) Appl. No.: 16/036,637

(22) Filed: Jul. 16, 2018

Related U.S. Application Data
(60) Provisional application No. 62/535,671, filed on Jul. 21, 2017.

(51) Int. Cl. G08B 29/04; G08B 13/196; G06F 9/54; G08B 29/18; G06K 9/00; G08B 31/00; G06Q 10/00

(52) U.S. Cl. CPC G08B 29/04; G08B 13/19602; G06F 9/542; G06Q 10/20; G08B 13/19682; G06K 9/00288; G08B 31/00; G08B 29/185

(57) ABSTRACT

In some examples, artificial intelligence based service control and home monitoring may include ascertaining, from a monitoring tool, an alert related to operation of a device or service monitored by the monitoring tool, and generating, based on the alert, a support call that includes a phone call, an e-mail, a Short Message Service (SMS), and/or smart device notification to a support personnel. Based on an issue addressed in the alert, an incident ticket may be generated, and based on a response to the support call, and determination of a resolution to the issue addressed in the alert, the incident ticket may be modified to include the resolution. Further, a service level agreement may be analyzed, and based on an analysis of the alert, the support call, the incident ticket, and the service level agreement, metrics related to the resolution to the issue addressed in the alert may be generated.

### PRIORITY

This application is a Non-Provisional Application of commonly assigned and co-pending Provisional Application Ser. No. 62/535,671, filed Jul. 21, 2017, the disclosure of which is hereby incorporated by reference in its entirety.

### BACKGROUND

In an enterprise environment, a variety of tools and/or people may be used to monitor and control the operation of systems. For example, if a server is down, a service technician may be contacted to repair the server. The service technician may complete a work-order that specifies the issues with the server, and the work performed on the server to address any defects. Similarly, in a home environment, security systems may be used to monitor a status of a home. For example, in the event of an intruder that makes an unauthorized entry into a home, an alarm may be generated.

### BRIEF DESCRIPTION OF DRAWINGS

Features of the present disclosure are illustrated by way of example and not limited in the following figure(s), in which like numerals indicate like elements, in which:

FIG. 1 illustrates a layout of an artificial intelligence based service control and home monitoring apparatus in accordance with an example of the present disclosure;

FIG. 2A illustrates a logical layout of the artificial intelligence based service control and home monitoring apparatus of FIG. 1 in accordance with an example of the present disclosure;

FIG. 2B illustrates ticket creation to illustrate operation of the artificial intelligence based service control and home monitoring apparatus of FIG. 1 in accordance with an example of the present disclosure;

FIG. 2C illustrates an example of a ticket to illustrate operation of the artificial intelligence based service control and home monitoring apparatus of FIG. 1 in accordance with an example of the present disclosure;

FIG. 2D illustrates English request/translation of the ticket to illustrate operation of the artificial intelligence based service control and home monitoring apparatus of FIG. 1 in accordance with an example of the present disclosure;

FIG. 2E illustrates current status of an untranslated request to illustrate operation of the artificial intelligence based service control and home monitoring apparatus of FIG. 1 in accordance with an example of the present disclosure;

FIG. 2F illustrates change of status to translated request and ticket assignment to illustrate operation of the artificial intelligence based service control and home monitoring apparatus of FIG. 1 in accordance with an example of the present disclosure;

FIG. 2G illustrates entry of a comment such as “to be started” (TBS) to illustrate operation of the artificial intelligence based service control and home monitoring apparatus of FIG. 1 in accordance with an example of the present disclosure;

FIG. 2H illustrates saving of translation and modification of a ticket to illustrate operation of the artificial intelligence based service control and home monitoring apparatus of FIG. 1 in accordance with an example of the present disclosure;

FIG. 2I illustrates response (e.g., in Italian) and translation (e.g., to English) of a resolution to illustrate operation of the artificial intelligence based service control and home monitoring apparatus of FIG. 1 in accordance with an example of the present disclosure;

FIG. 2J illustrates closing of a ticket and saving to illustrate operation of the artificial intelligence based service control and home monitoring apparatus of FIG. 1 in accordance with an example of the present disclosure;

FIG. 3 illustrates an example block diagram for artificial intelligence based service control and home monitoring in accordance with an example of the present disclosure;

FIG. 4 illustrates a flowchart of an example method for artificial intelligence based service control and home monitoring in accordance with an example of the present disclosure; and

FIG. 5 illustrates a further example block diagram for artificial intelligence based service control and home monitoring in accordance with another example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Artificial intelligence based service control and home monitoring apparatuses, methods for artificial intelligence based service control and home monitoring, and non-transitory computer readable media having stored thereon machine readable instructions to provide artificial intelligence based service control and home monitoring are disclosed herein. The apparatuses, methods, and non-transitory computer readable media disclosed herein provide for ascertaining, from a monitoring tool, an alert related to operation of a device or service monitored by the monitoring tool, and generating, based on the alert, a support call that includes a phone call, an e-mail, a Short Message Service (SMS), and/or smart device communication, (or another type of alert) to a support personnel. The apparatuses, methods, and non-transitory computer readable media disclosed herein further provide for generating, based on an issue addressed in the alert, an incident ticket related to the alert, and modifying, based on a response to the support call from the support personnel, the incident ticket to include a resolution to the issue addressed in the alert. The apparatuses, methods, and non-transitory computer readable media disclosed herein further provide for analyzing a service level agreement related to the operation of the device or service monitored by the monitoring tool, and generating, based on an analysis of the alert, the support call, the incident ticket, and the service level agreement, metrics related to the resolution to the issue addressed in the alert.

According to another example, the apparatuses, methods, and non-transitory computer readable media disclosed herein provide for detecting, based on an analysis of a video stream, a face of a person in the video stream, comparing the detected face to images of faces associated with an authorized user, and analyzing an emotion associated with the detected face. Further, the apparatuses, methods, and non-transitory computer readable media disclosed herein further provide for generating, based on the comparison of the detected face and the analysis of the emotion, an alert to the authorized user via a phone call, an e-mail, a Short Message Service (SMS), and/or smart device communication, or another type of alert. The alert may include an indication of an intruder status of the detected face, and/or an image of the detected face.

According to examples disclosed herein, the apparatuses, methods, and non-transitory computer readable media disclosed herein may provide for integration into various social media outlets. An example of a social media outlet may include FACEBOOK MESSENGER. In this regard, the apparatuses, methods, and non-transitory computer readable media disclosed herein may dispatch an alert to an assigned account, for example, via a social media outlet. Further, the apparatuses, methods, and non-transitory computer readable media disclosed herein may accept the acknowledgement of a created ticket via a social media outlet. The apparatuses, methods, and non-transitory computer readable media disclosed herein may be integrated with various cloud-based voice service devices where a user may inquire about the status of a ticket. An example of a cloud-based voice service device may include AMAZON ALEXA, where a user may inquire about the status of a ticket, for example, using ALEXA BOT. The apparatuses, methods, and non-transitory computer readable media disclosed herein may be integrated with an interactive agent. An example of an interactive agent may include a CHATBOT. In this regard, the apparatuses, methods, and non-transitory computer readable media disclosed herein may include a CHATBOT using, for example, FACEBOOK MESSENGER for inquiries and status of tickets. Further, the apparatuses, methods, and non-transitory computer readable media disclosed herein may be integrated with tools such as GOOGLE DIALOG FLOW for the responses and machine learning related to a CHATBOT.

The apparatuses, methods, and non-transitory computer readable media disclosed herein address technical challenges to technical problems related, for example, to service control and home monitoring. With respect to service control, the apparatuses, methods, and non-transitory computer readable media disclosed herein address technical challenges to technical problems related, for example, to monitoring of a device or service, and generation of a support call to a support personnel based on an alert. In this regard, the apparatuses, methods, and non-transitory computer readable media disclosed herein address technical challenges to technical problems related, for example, to determination of a resolution related to an issue addressed in the alert, generation of an incident ticket related to the alert, and modification of the incident ticket to include the resolution to the issue addressed in the alert. Yet further, with respect to home monitoring, the apparatuses, methods, and non-transitory computer readable media disclosed herein address technical challenges to technical problems related, for example, to detection, based on an analysis of a video stream, of an intruder, and notification of the intruder to an authorized user. The apparatuses, methods, and non-transitory computer readable media disclosed herein may also address technical challenges to technical problems related, for example, to support of existing systems that do not include a built in monitoring system. In this regard, the apparatuses, methods, and non-transitory computer readable media disclosed herein may implement plug-in capability into an existing monitoring system to provide service control and home monitoring.

According to examples disclosed herein, the apparatuses, methods, and non-transitory computer readable media disclosed herein may provide service desk functionality where multiple resources may be needed for monitoring critical alerts. For example, every time a critical alert is received based on a specified threshold as disclosed herein, the critical alert and ticket details may be dispatched to support personnel via resources such as phone call, SMS, and/or email. If the phone call, SMS, and the email are not acknowledged, an escalation procedure may be used to dispatch the phone call, SMS, and the email to a next level support personnel. The support personnel may receive an alert with respect to the critical alert, and various parameters related to the alert such as receipt time, acknowledgment time, resolution time, and other details with respect to the ticket may be logged.

According to examples disclosed herein, the apparatuses, methods, and non-transitory computer readable media disclosed herein may provide home security functionality. In this regard, a homeowner may have an Internet protocol camera set up in their home. In the event an intruder comes into the view of the camera, the apparatuses, methods, and non-transitory computer readable media disclosed herein may notify the homeowner of the intruder status of the person that comes into the view of the camera.

According to examples disclosed herein, the apparatuses, methods, and non-transitory computer readable media disclosed herein may be customized/configured on monitoring existing platforms such as (Nagios XI, Service Now, OTRS, and any other monitoring tools). In this regard, the apparatuses, methods, and non-transitory computer readable media disclosed herein may include a pre-define script to monitor existing platforms, or if there is an API for the existing tool, such a tool may be integrated with the apparatuses, methods, and non-transitory computer readable media disclosed herein.

According to examples disclosed herein, the apparatuses, methods, and non-transitory computer readable media disclosed herein may create a ticket related to an alert using the exposed Web Service API. In this regard, a project may define which information/details are needed for tracking tickets.

According to examples disclosed herein, the apparatuses, methods, and non-transitory computer readable media disclosed herein may generate a resolution to an incident.

For the apparatuses, methods, and non-transitory computer readable media disclosed herein, the elements of the apparatuses, methods, and non-transitory computer readable media disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

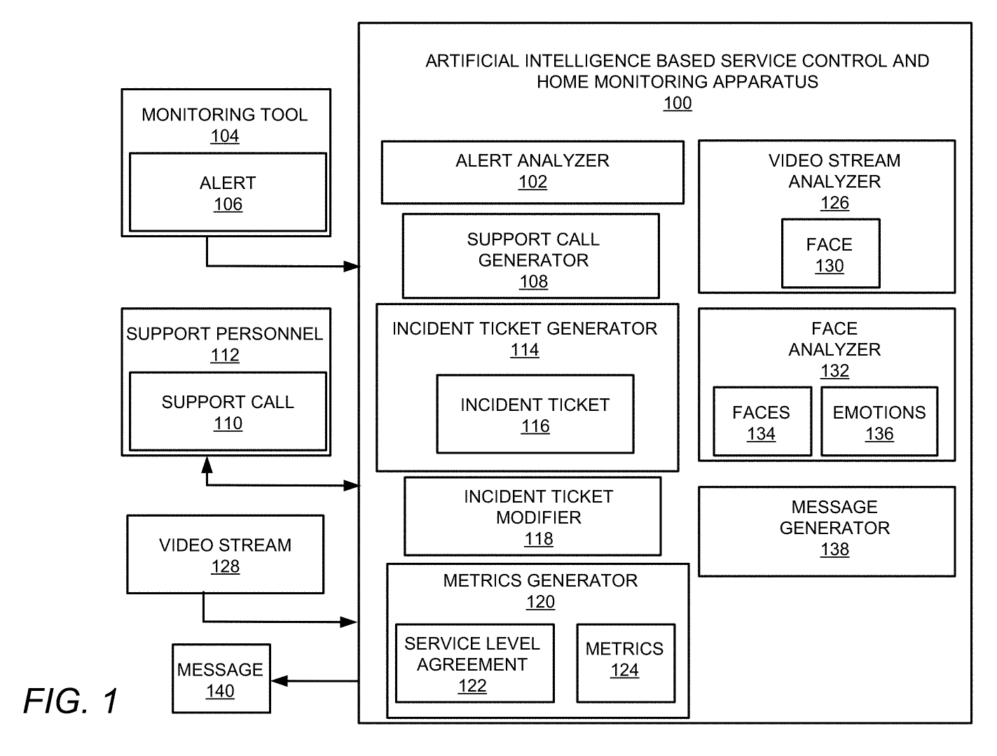

FIG. 1 illustrates a layout of an example artificial intelligence based service control and home monitoring apparatus (hereinafter also referred to as “apparatus 100”).

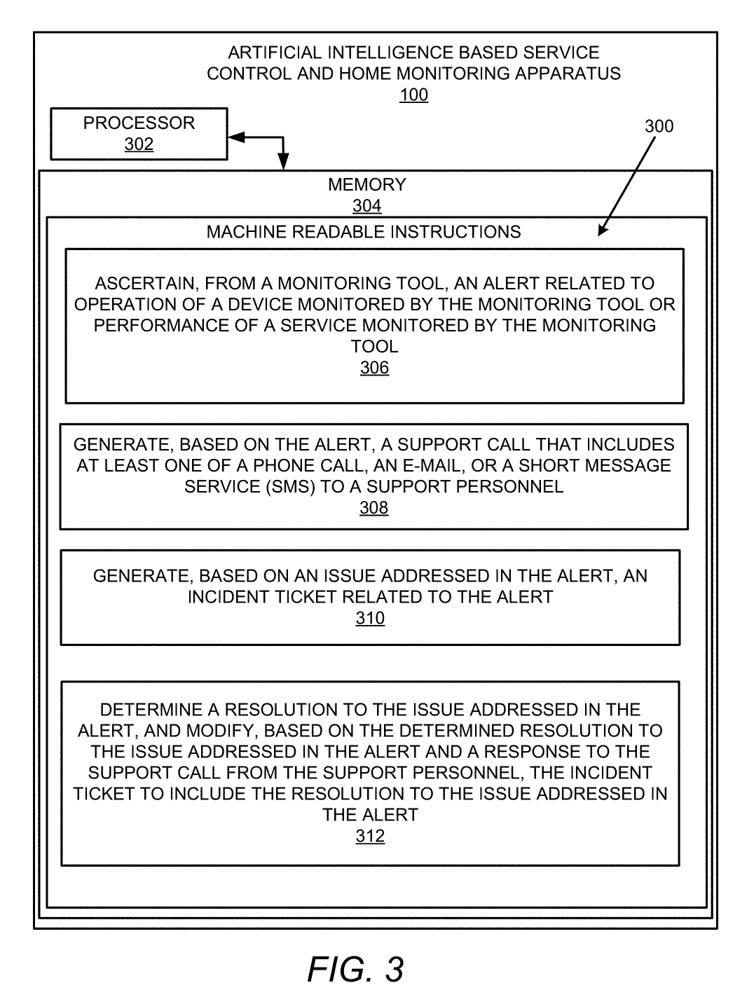

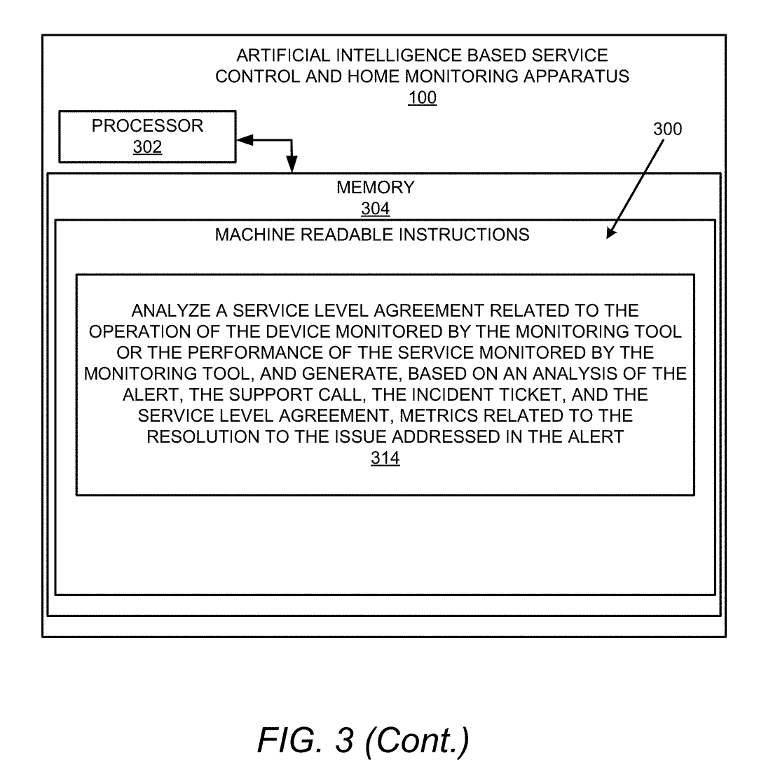

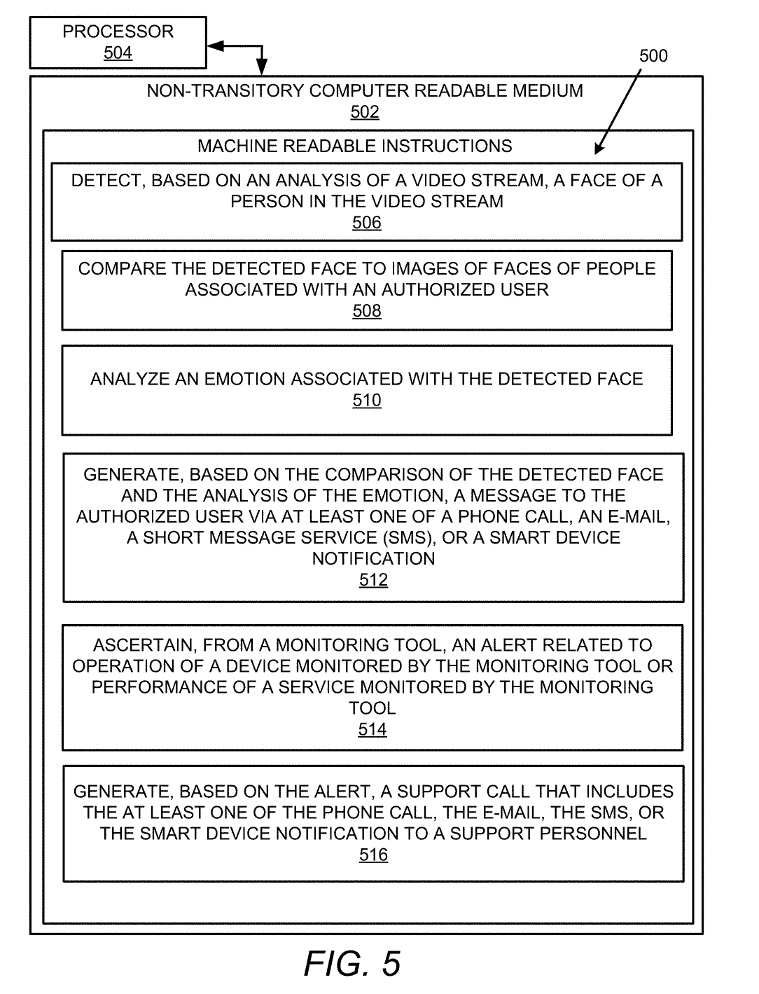

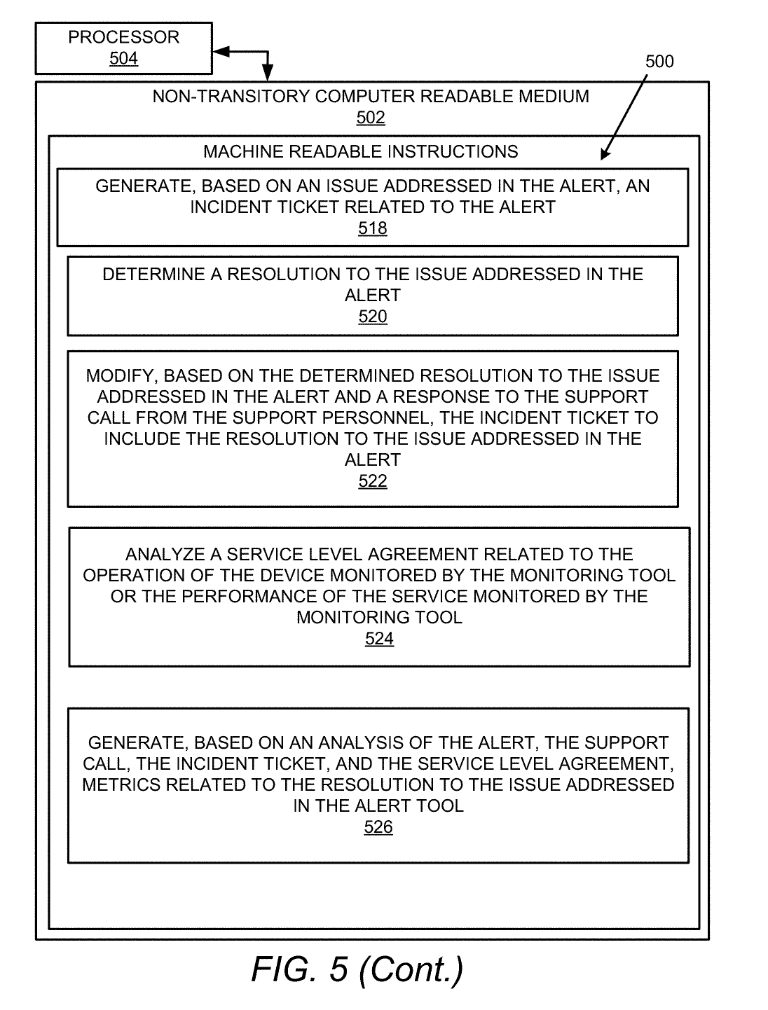

Referring to FIG. 1, the apparatus 100 may include an alert analyzer 102 that is executed by at least one hardware processor (e.g., the hardware processor 302 of FIG. 3, and/or the hardware processor 504 of FIG. 5) to ascertain, from a monitoring tool 104, an alert 106 related to operation of a device monitored by the monitoring tool 104 or performance of a service monitored by the monitoring tool 104.

According to examples disclosed herein, the alert analyzer 102 may ascertain, from the monitoring tool 104, the alert related to operation of the device monitored by the monitoring tool 104 or performance of the service monitored by the monitoring tool 104 by ascertaining the alert based on a determination by the monitoring tool 104 that an alert signal level related to the operation of the device or the performance of the service exceeds a specified signal level threshold. For example, the specified signal level threshold may represent a numerical value or an electrical signal level value that may need to be exceeded for generation of the alert.

With respect to device operation monitoring and alert generation, the apparatus 100 may utilize, for example, a pre-defined script/JAR file based, for example, on project specifications. According to an example, for third party tools that do not include an exposed Web Service application programming interface (API), the apparatus 100 may utilize a pre-defined script/JAR that directly monitors the database with a certain threshold based on the project specification. According to an example, the script may be executed at a predefined interval (e.g., every five minutes) to check all alerts, for example, with a “critical” status. Once a “critical” alert status has been identified, the script may call/trigger the Web Service exposed by the apparatus 100 on creating a ticket, sending an SMS, sending a call, etc. According to another example, for third party tools that have an exposed Web Service API on fetching critical alerts, the apparatus 100 may be configured to execute a scheduler to perform monitoring (e.g., every five minutes) to determine if data has been retrieved. If data has been retrieved, the apparatus 100 may proceed to call the exposed Web Service on creating a ticket, sending an SMS, sending a call, etc.

A support call generator 108 that is executed by at least one hardware processor (e.g., the hardware processor 302 of FIG. 3, and/or the hardware processor 504 of FIG. 5) may generate, based on the alert 106, a support call 110 that includes a phone call, an e-mail, and/or a SMS to a support personnel 112.

According to examples disclosed herein, the support call generator 108 may generate, based on the alert, the support call that includes the phone call, the e-mail, the SMS, and/or the smart device notification to the support personnel by determining a severity level for the alert from a plurality of severity levels (e.g., severity levels ranging from 1-10), determining, based on the severity level, whether the support call is to include the phone call, the email, the SMS, and/or the smart device notification, and generating, based on the alert and the determined severity level, the support call that includes the phone call, the e-mail, the SMS, and/or the smart device notification to the support personnel. For example, a low severity level of 1 may require generation of an SMS, a medium severity level of 5 may require generation of an SMS and an e-mail, and whereas a high severity level of 10 may require generation of the phone call, the e-mail, the SMS, and the smart device notification.

According to examples disclosed herein, the support call generator 108 may generate, based on the alert, the support call that includes the phone call, the e-mail, the SMS, and/or the smart device notification to the support personnel by determining a severity level for the alert from a plurality of severity levels, determining, based on the severity level, whether the support call is to specifically exclude the phone call, the email, the SMS, or the smart device notification, and generating, based on the alert and the determined severity level, the support call that specifically excludes the phone call, the e-mail, the SMS, or the smart device notification to the support personnel. For example, assuming that a severity level 6 specifically excludes a phone call, then the support call may be generated to include only the e-mail, the SMS, and the smart device notification.

According to examples disclosed herein, the support call generator 108 may generate, based on the alert, the support call that includes the phone call, the e-mail, the SMS, and/or the smart device notification to the support personnel by determining a severity level for the alert from a plurality of severity levels, determining, based on the severity level, whether the support call is to include the phone call, the email, the SMS, and/or the smart device notification, determining, based on the severity level, a priority order of the phone call, the email, the SMS, and/or the smart device notification, and generating, based on the alert, the determined severity level, and the determined priority order, the support call that includes, according to the determined priority order, the phone call, the e-mail, the SMS, and/or the smart device notification to the support personnel. For example, assuming that a severity level 7 requires the phone call, the e-mail, and the SMS, but specifies a priority of SMS, then e-mail, and then phone call, then the support call may be generated according to the noted priority order.

With respect to a decision to generate a phone call, an e-mail, and/or an SMS, whenever there is a “critical” alert, a phone call, an e-mail, and an SMS may be dispatched. In this regard, depending on the severity of an alert, an email notification (or another type of notification) may be eliminated. Thus, the urgency of a phone call versus an SMS may be defined based on ticket severity. The destination of the phone call, the e-mail, and the SMS may be is defined on the saved details of a project including, for example, an escalation process that defines different types of communication techniques based on ticket severity.

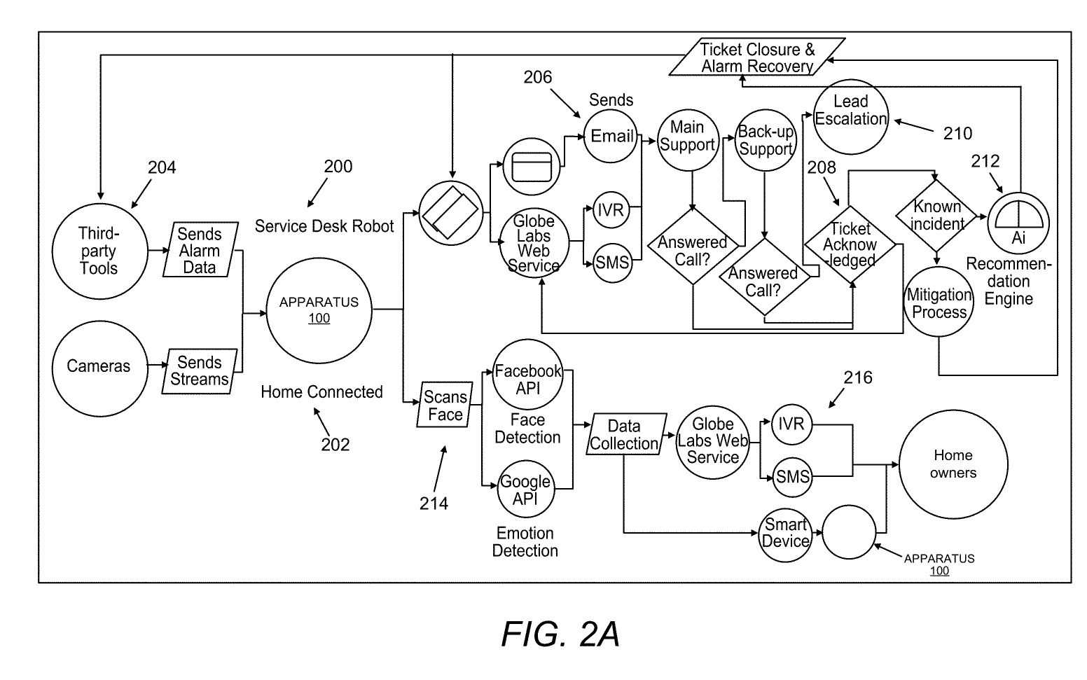

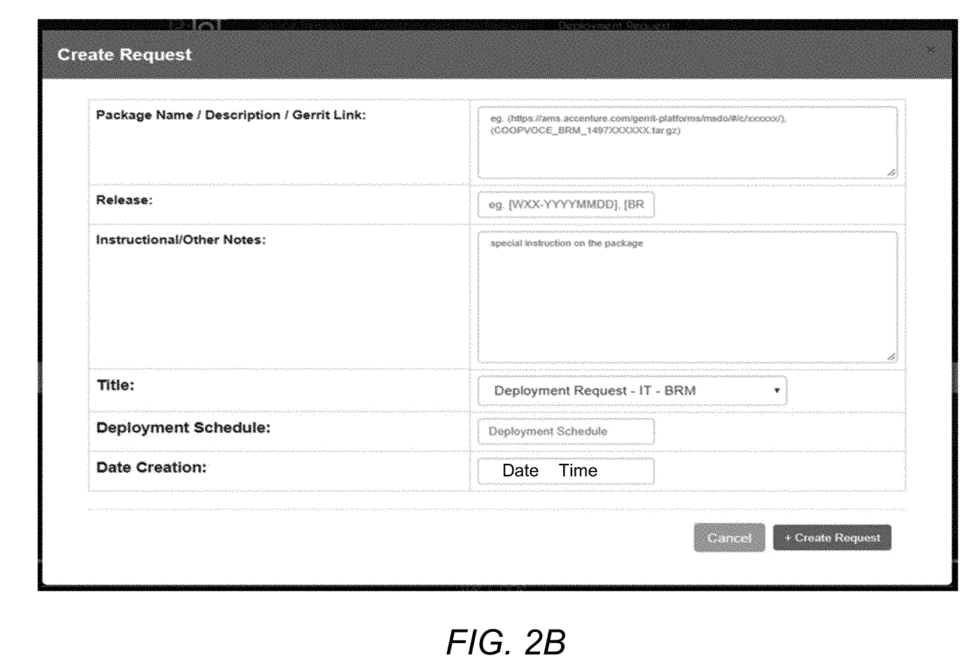

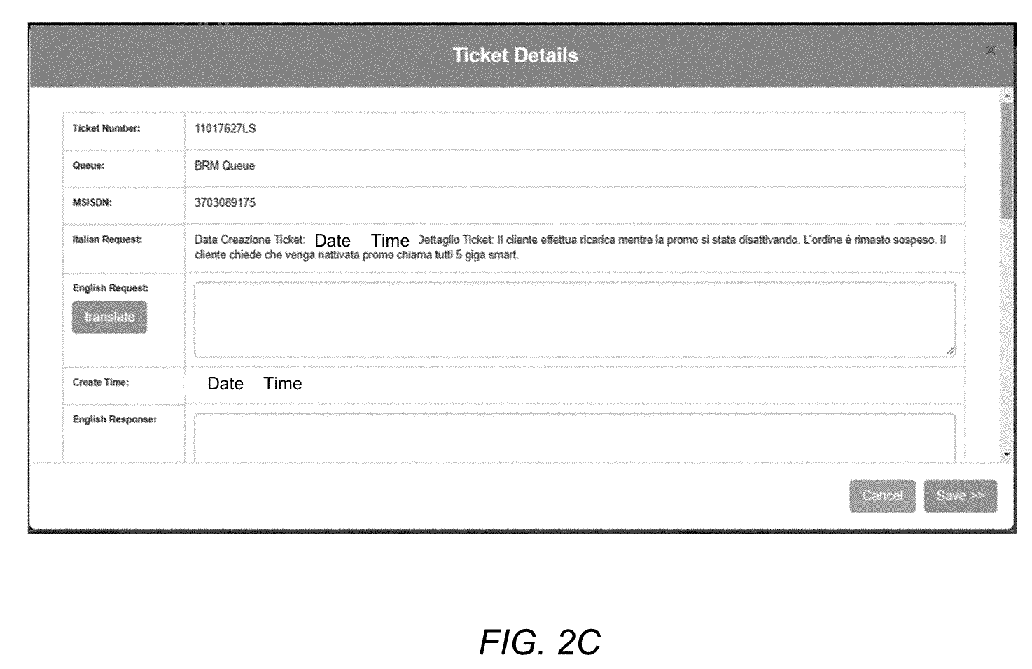

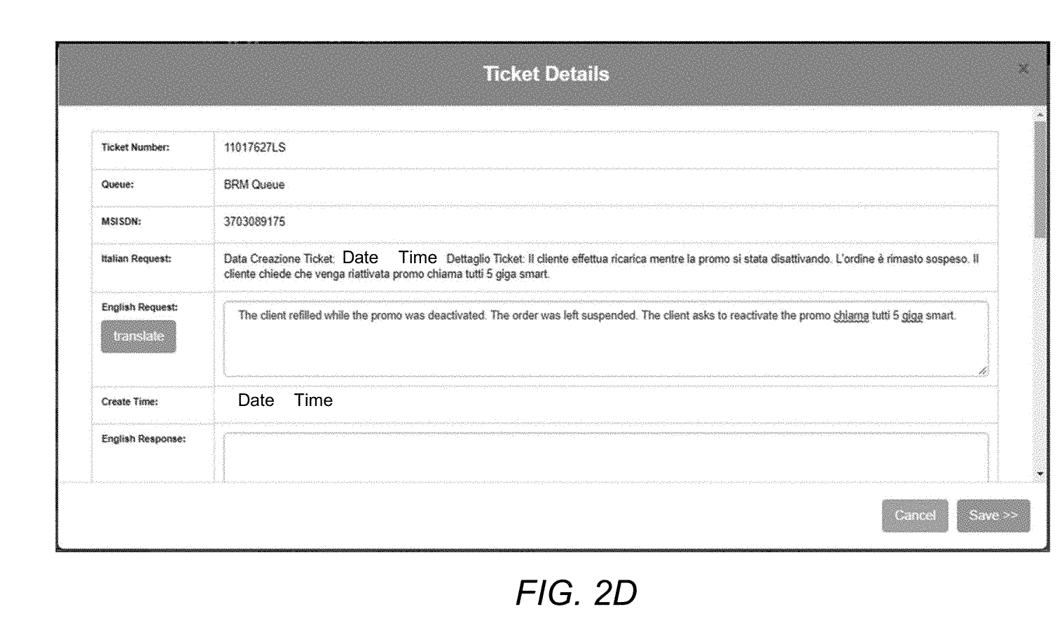

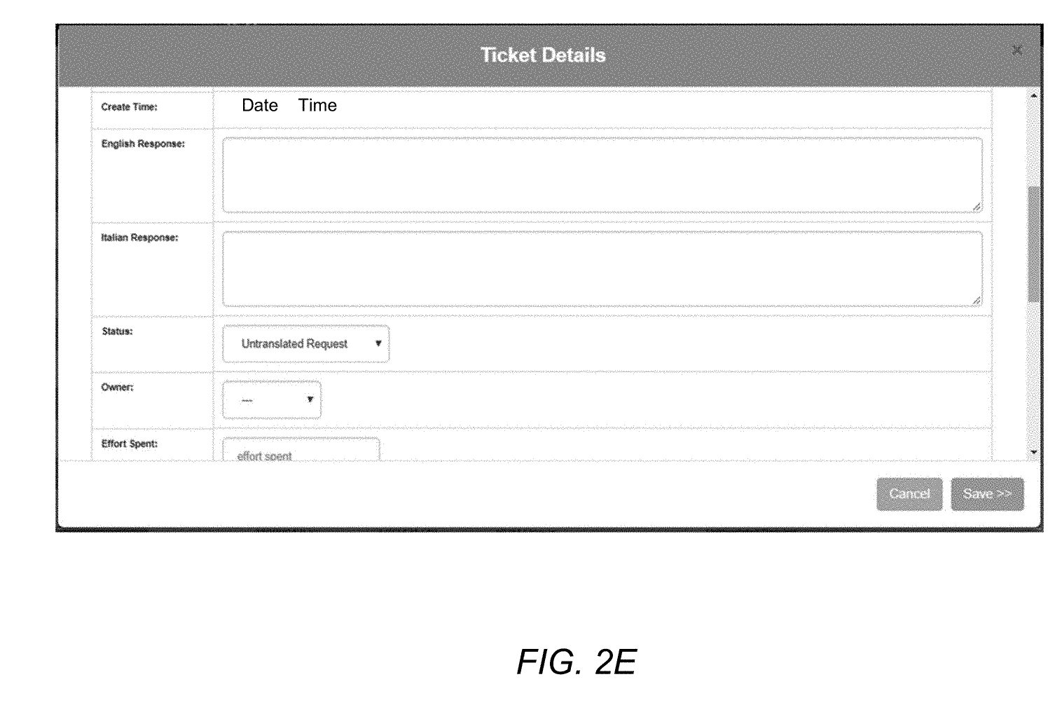

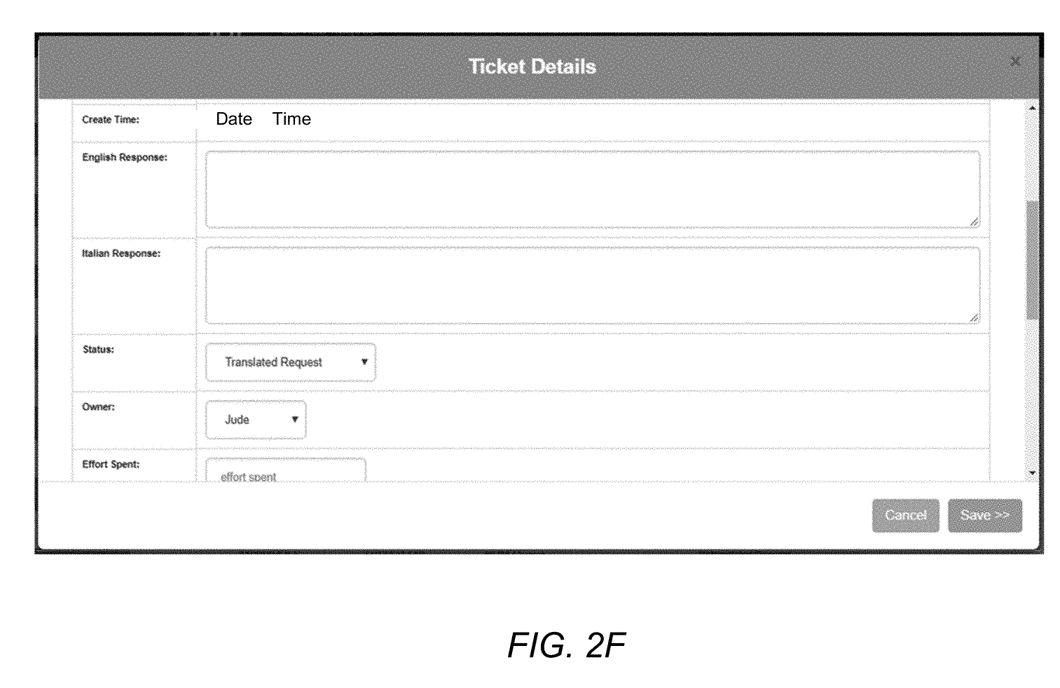

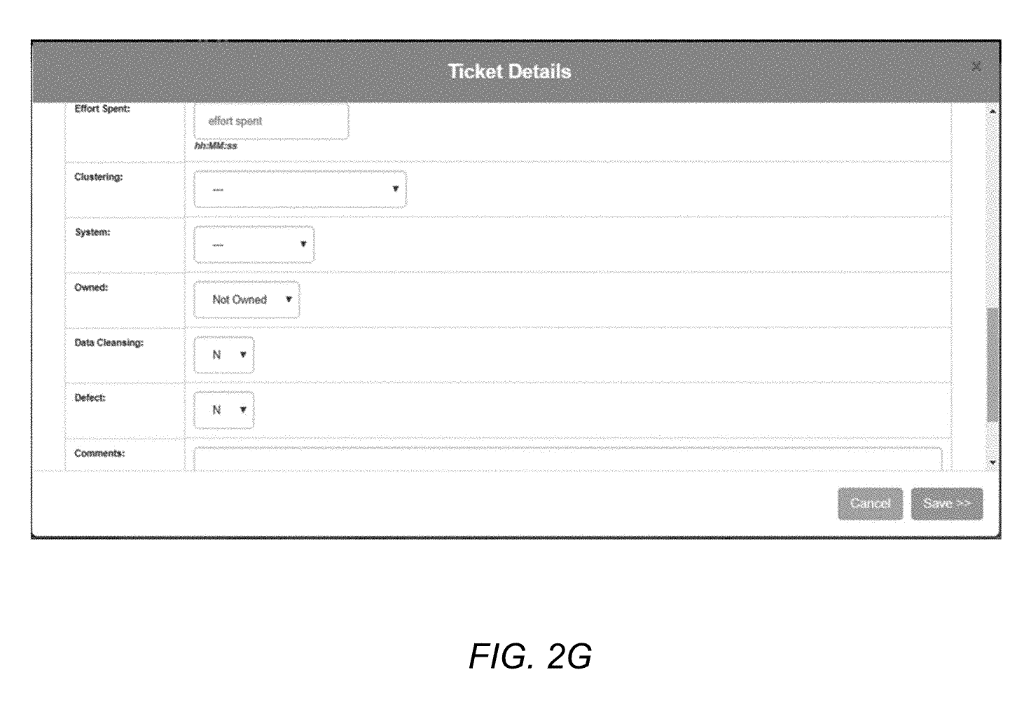

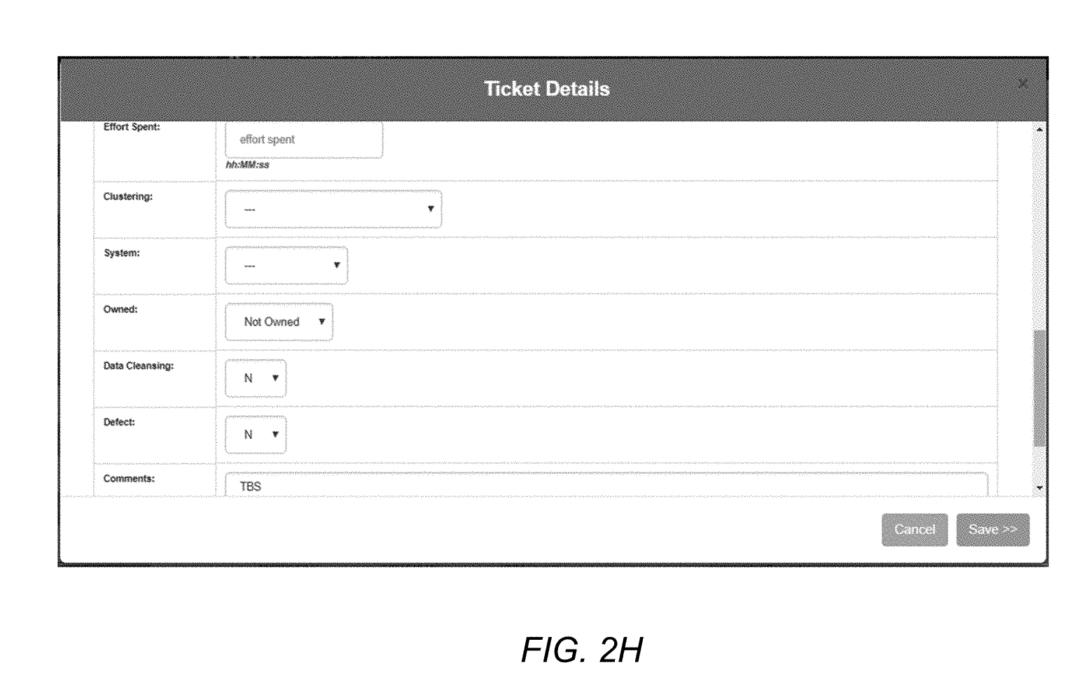

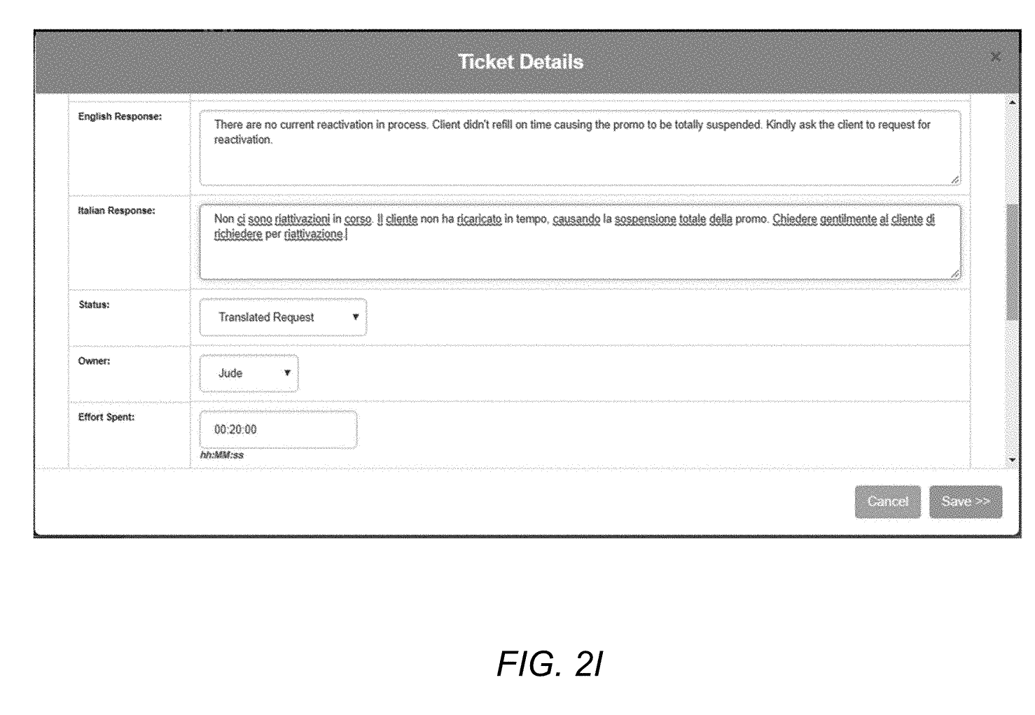

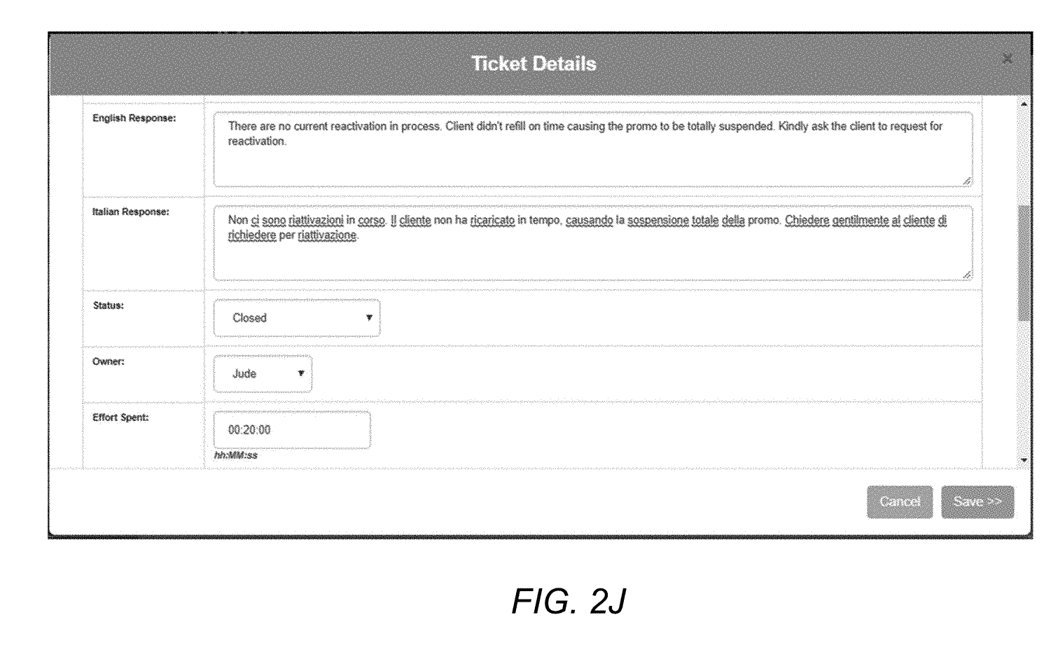

An incident ticket generator 114 that is executed by at least one hardware processor (e.g., the hardware processor 302 of FIG. 3, and/or the hardware processor 504 of FIG. 5) may generate, based on an issue addressed in the alert 106, an incident ticket 116 related to the alert 106. Examples of incident ticket creation and related processing are disclosed herein with respect to FIGS. 2B-2J.

With respect addressing an issue to generate the incident ticket, an issue may be detected, for example, by hardware, network, server monitoring, and alerting tools. In this regard, a Web Service API may be called whenever there is an immediate alert, and action is to be taken, The Web Service AH may create the incident ticket 116, and perform calculations of time received, time acknowledged, and time resolved. An escalation process may be utilized so that an incident is not missed, and processing may continue until the alert related to the incident ticket 116 is addressed.

An incident ticket modifier 118 that is executed by at least one hardware processor (e.g., the hardware processor 302 of FIG. 3, and/or the hardware processor 504 of FIG. 5) may determine a resolution to the issue addressed in the alert 106. Further, the incident ticket modifier 118 may modify, based on the determined resolution to the issue addressed in the alert 106 and a response to the support call 110 from the support personnel 112, the incident ticket 116 to include the resolution to the issue addressed in the alert 106.

According to examples disclosed herein, the incident ticket modifier 118 may determine the resolution to the issue addressed in the alert by identifying, from a set of historical alerts, a plurality of alerts that are similar to the ascertained alert, identifying an alert of the plurality of alerts that is most similar to the ascertained alert, ascertaining a resolution for the most similar alert, and utilizing the ascertained resolution for the most similar alert as the resolution to the issue addressed in the ascertained alert. For example, the incident ticket modifier 118 may identify similar alerts by comparing the ascertained alert to different types of alerts of the set of historical alerts. Further, the incident ticket modifier 118 may identify the most similar alert as the alert which includes the most similar attributes (e.g., location, time, signal level, etc.) to one of the plurality of alerts.

With respect to resolution identification to address the issue addressed in the alert 106, the resolution of the specific alert 106 may be identified based on a history of resolutions mapped to similar alerts. For example, if the alert 106 is new (e.g., never before encountered), resolution flagging may be unknown, and support personnel may add a resolution procedure for this specific alert. Alternatively, if the alert 106 is known, all of the history of this specific alert may be compiled and analyzed to provide the resolution details defined for the specific alert.

A metrics generator 120 that is executed by at least one hardware processor (e.g., the hardware processor 302 of FIG. 3, and/or the hardware processor 504 of FIG. 5) may analyze a service level agreement 122 related to the operation of the device monitored by the monitoring tool 104 or the performance of the service monitored by the monitoring tool 104. Further, the metrics generator 120 may generate, based on an analysis of the alert 106, the support call 110, the incident ticket 116, and the service level agreement 122, metrics 124 related to the resolution to the issue addressed in the alert 106.

With respect to determination of metrics based on the analysis of the alert 106, the support call 110, the incident ticket 116, and the service level agreement 122, the metrics may be determined based on the needed ticket details provided from the Web Service API call on creation of the incident ticket 116. In this regard, the mapping may be defined for the service level agreement 122 of the specific ticket. Further, the metrics may be analyzed based on the severity of the alert 106.

A table may be utilized to map all of the alerts identified, and the service level agreement 122 for each alert 106 may be added/edited in the table.

With respect to utilization of the metrics, the metrics may be utilized, for example, for weekly submissions. For example, the metrics may be utilized for weekly conserved domain architecture retrieval tool (CDART) submissions to determine the needed information and details of the incident ticket 116 such as service request tickets, incidents request tickets, deployment request tickets, etc. The metrics may also be utilized in an intelligent automation tool to generate a specified format file as needed.

A video stream analyzer 126 that is executed by at least one hardware processor (e.g., the hardware processor 302 of FIG. 3, and/or the hardware processor 504 of FIG. 5) is to detect, based on an analysis of a video stream 128, a face 130 of a person in the video stream 128.

The face 130 may be detected based on analysis of the video stream 128 received, for example, from a web camera or any available camera in place. Once the face 130 is detected, an image of the face may be captured and analyzed based on emotion and face recognition.

A face analyzer 132 that is executed by at least one hardware processor (e.g., the hardware processor 302 of FIG. 3, and/or the hardware processor 504 of FIG. 5) is to compare the detected face 130 to images of faces 134 of people associated with an authorized user, and analyze an emotion 136 associated with the detected face 130.

According to examples disclosed herein, the face analyzer 132 may compare the detected face to images of faces of people associated with the authorized user by analyzing, for a social media website, a friend list associated with the authorized user, and determining whether the detected face matches the images of faces of people in the friend list associated with the authorized user.

According to examples disclosed herein, the face analyzer 132 may compare the detected face to images of faces of people associated with the authorized user by analyzing a pre-specified list of people associated with the authorized user, and determining whether the detected face matches the images of faces of the pre-specified list of people associated with the authorized user.

Upon face detection, the image captured on the video stream may be verified by using a third party API for emotions and face recognition. Based on the response of the third party API, the image captured on the video stream may be analyzed by referencing on the data saved on the database. For example, the verification for face recognition may be based on a friend list. In this regard, if a specific detected face is not in the friend list, the detected face may be considered as being associated with an unauthorized person as disclosed herein.

A message generator 138 that is executed by at least one hardware processor (e.g., the hardware processor 302 of FIG. 3, and/or the hardware processor 504 of FIG. 5) may generate, based on the comparison of the detected face 130 and the analysis of the emotion, a message 140 (e.g., a notification different than the alert 106) to the authorized user via a phone call, an e-mail, and/or a SMS. The message 140 may include an indication of an intruder status of the detected face 130, and/or an image of the detected face 130.

According to examples disclosed herein, the face analyzer 132 may analyze the emotion associated with the detected face, and the message generator 138 may generate, based on the comparison of the detected face and the analysis of the emotion, the message to the authorized user via the phone call, the e-mail, the SMS, and/or the smart device notification by determining whether the emotion associated with the detected face matches a predetermined emotion of a plurality of predetermined emotions, and based on a determination that the emotion associated with the detected face matches the predetermined emotion of the plurality of predetermined emotions, generating, based on the comparison of the detected face and the matched predetermined emotion, the message to the authorized user via the phone call, the e-mail, the SMS, and/or the smart device notification that corresponds to the matched predetermined emotion. For example, predetermined emotions may include calm, happy, sad, etc. Further, a phone call may be matched to a calm emotion, an SMS may be matched to a sad emotion, etc. Thus, based on the emotion associated with the detected face, the message to the authorized user may be generated via the phone call, the e-mail, the SMS, and/or the smart device notification that corresponds to the matched predetermined emotion.

According to examples disclosed herein, the message generator 138 may generate, based on the comparison of the detected face and the analysis of the emotion, the message to the authorized user via the phone call, the e-mail, the SMS, and/or the smart device notification, and the message may include the indication of the intruder status of the detected face, and/or the image of the detected face, by determining, based on the comparison of the detected face to images of faces of people associated with the authorized user, whether the detected face matches an image of the images of faces of people associated with the authorized user, determining, based on a determination that the detected face does not match any of the images of faces of people associated with the authorized user, that the detected face represents an intruder, and generating the message to indicate the intruder status of the detected face.

Upon face detection, the image captured from the video stream may be analyzed relative to a social media API for face recognition (e.g., by determining whether the face is in a user's friend list). Upon determining whether the face is in the user's friend list, the message 140 to the authorized user may be generated via a phone call, an e-mail, and/or a SMS to verify if the person's face/Image is known.

FIG. 2A illustrates a logical layout of the apparatus 100 in accordance with an example of the present disclosure.

Referring to FIG. 2A, the service control functionality of the apparatus 100 may be specified as a “service desk robot” at 200 in FIG. 2A, and the home monitoring functionality of the apparatus 100 may be specified as “home connected” at 202 in FIG. 2A.

The third party tools at 204 may represent the monitoring tool 104, which may be used to ascertain the alert 106 related to operation of a device or service monitored by the monitoring tool 104. The monitoring tool 104 may monitor a health of the device or service. Examples of devices may include computer systems, servers, mechanical devices, electrical devices, etc. Examples of services may include processes related to mail services, transportation services, delivery services, etc.

As shown at 206, the support call generator 108 is to generate, based on the alert 106, a support call 110 that includes a phone call, an e-mail, and/or a SMS to the support personnel 112.

As shown at 208, the incident ticket generator 114 is to generate, based on an issue addressed in the alert 106, the incident ticket 116 related to the alert 106. Further, the incident ticket modifier 118 is to modify, based on a response to the support call 110 from the support personnel 112, the incident ticket 116 to include a resolution to the issue addressed in the alert 106.

The incident ticket generator 114 may also send reminders to the support personnel 112 if the incident ticket 116 is not resolved in a specified time (e.g., 20 minutes, etc.). The reminders may be sent via a phone call, an e-mail, and/or a SMS to the support personnel 112.

If the reminder is not addressed within a specified time, as shown at 210, the incident ticket generator 114 may escalate the incident ticket 116 to secondary or lead support personnel.

At 212, the metrics generator 120 may analyze a service level agreement 122 related to the operation of the device or service monitored by the monitoring tool 104. Further, the metrics generator 120 is to generate, based on an analysis of the alert 106, the support call 110, the incident ticket 116, and the service level agreement 122, metrics 124 related to the resolution to the issue addressed in the alert 106. In this regard, the metrics generator 120 may determine various metrics on a recurring basis (e.g., weekly). The metrics may include, for example, types of alerts, types of issues addressed in the alerts, resolutions, support personnel involved, whether escalation was needed, timings related to alerts and resolution, types of communication, etc. These metrics may be used in the future for issue resolution, for example, where the support call generator 108 may specify possible resolutions to an issue addressed in the alert. Alternatively or additionally, for certain issues, the support call generator 108 may generate a support call, but also automatically (e.g., without human intervention) resolve certain issues that have been previously addressed, or where artificial intelligence is used to determine a resolution.

With respect to the support call generator 108 that may generate a support call and also automatically (e.g., without human intervention) resolve certain issues that have been previously addressed, or where artificial intelligence is used to determine a resolution, artificial intelligence may be used to determine a resolution based on previous data inputs of a support team. In this regard, information on specific alerts may be used to make a resolution more effective. In this regard, artificial intelligence may be used to determine who to contact/call upon the occurrence of an incident. The artificial intelligence may be used to determine when the contact/call is to be escalated to backup person. Further, the artificial intelligence may determine the time-interval of the incident not acknowledged on a specific service level agreement (e.g., 30 minutes/1hour).

At 214, the video stream analyzer 126 is to detect, based on an analysis of a video stream 128, a face 130 of a person in the video stream 128. Further, the face analyzer 132 is to compare the detected face 130 to images of faces 134 associated with an authorized user, and analyze an emotion 136 associated with the detected face 130. In this regard, the faces 134 may be retrieved, for example, from social media sites (e.g., FACEBOOK™, etc.) related to the authorized user. If the face 130 matches one of the faces 134 from a social media site, a different type of message 140 may be provided (e.g., a name of the friend, an image of the friend, greetings to the friend, etc.).

The faces 134 may also be retrieved from pre-specified groups of people (e.g., home maintenance personnel, mailman, etc.) related to the authorized user. In this regard, for certain people (e.g., a mailman), an alert may be bypassed.

With respect to the emotion 136, the emotion 136 may be analyzed to determine a mood of the person for the detected face 130. For example, the mood may be classified in a plurality of categories by performing analysis of a smile, eye position, etc., of the person for the detected face 130. For example, the categories may include happy, sad, angry, etc. An associated emoticon may be provided to the authorized user along with the image of the detected face 130.

If the face 130 is unrecognized, at 216, the message generator 138 is to generate, based on the comparison of the detected face 130 and the analysis of the emotion, an message 140 (e.g., a notification different than the alert 106) to the authorized user via a phone call, an e-mail, and/or a SMS. The message 140 may include an indication of an intruder status of the detected face 130, and/or an image of the detected face 130.

The face detection as disclosed herein may be used in a variety of environments, such as homes, businesses, banks, secured areas, etc.

The face detection as disclosed herein may also provide a real-time view of the area being monitored, for example, by a camera that captures the face 130.

The face detection as disclosed herein may also provide other types of alerts, such as fire, electrical outage, internet outage, etc.

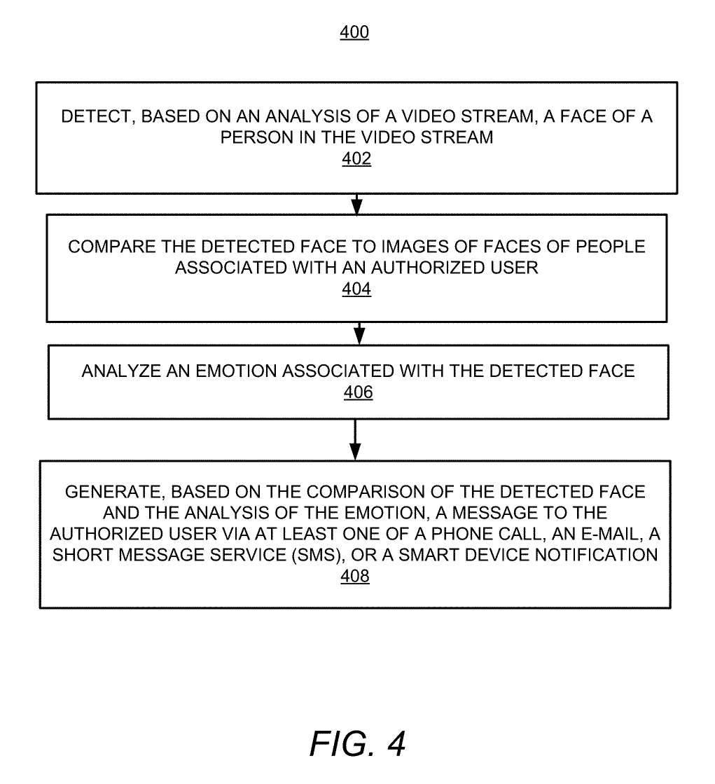

FIGS. 3-5 respectively illustrate an example block diagram 300, a flowchart of an example method 400, and a further example block diagram 500 for artificial intelligence based service control and home monitoring, according to examples. The block diagram 300, the method 400, and the block diagram 500 may be implemented on the apparatus 100 described above with reference to FIG. 1 by way of example and not of limitation. The block diagram 300, the method 400, and the block diagram 500 may be practiced in other apparatus. In addition to showing the block diagram 300, FIG. 3 shows hardware of the apparatus 100 that may execute the instructions of the block diagram 300. The hardware may include a processor 302, and a memory 304 storing machine readable instructions that when executed by the processor cause the processor to perform the instructions of the block diagram 300. The memory 304 may represent a non-transitory computer readable medium. FIG. 4 may represent an example method for artificial intelligence based service control and home monitoring, and the steps of the method. FIG. 5 may represent a non-transitory computer readable medium 502 having stored thereon machine readable instructions to provide artificial intelligence based service control and home monitoring according to an example. The machine readable instructions, when executed, cause a processor 504 to perform the instructions of the block diagram 500 also shown in FIG. 5.

The processor 502 of FIG. 5 and/or the processor 304 of FIG. 3 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 502 of FIG. 5), such as hardware storage devices (e.g., RAM (random access memory), ROM (read only memory), EPROM (erasable, programmable ROM), EEPROM (electrically erasable, programmable ROM), hard drives, and flash memory). The memory 304 may include a RAM, where the machine readable instructions and data for a processor may reside during runtime.

Referring to FIGS. 1-3, and particularly to the block diagram 300 shown in FIG. 3, the memory 304 may include instructions 306 to ascertain, from a monitoring tool, an alert related to operation of a device monitored by the monitoring tool or performance of a service monitored by the monitoring tool.

The processor 302 may fetch, decode, and execute the instructions 308 to generate, based on the alert, a support call that includes a phone call, an e-mail, a Short Message Service (SMS), and/or a notification in smart devices to a support personnel.

The processor 302 may fetch, decode, and execute the instructions 310 to generate, based on an issue addressed in the alert, an incident ticket related to the alert.

The processor 302 may fetch, decode, and execute the instructions 312 to determine a resolution to the issue addressed in the alert, and modify, based on the determined resolution to the issue addressed in the alert and a response to the support call from the support personnel, the incident ticket to include the resolution to the issue addressed in the alert.

The processor 302 may fetch, decode, and execute the instructions 314 to analyze a service level agreement related to the operation of the device monitored by the monitoring tool or the performance of the service monitored by the monitoring tool, and generate, based on an analysis of the alert, the support call, the incident ticket, and the service level agreement, metrics related to the resolution to the issue addressed in the alert.

Referring to FIGS. 1, 2, and 4, and particularly FIG. 4, for the method 400, at block 402, the method may include detecting, by at least one hardware processor, based on an analysis of a video stream, a face of a person in the video stream.

At block 404, the method may include comparing, by the at least one hardware processor, the detected face to images of faces of people associated with an authorized user.

At block 406, the method may include analyzing, by the at least one hardware processor, an emotion associated with the detected face.

At block 408, the method may include generating, by the at least one hardware processor and based on the comparison of the detected face and the analysis of the emotion, a message to the authorized user via a phone call, an e-mail, a Short Message Service (SMS), and/or a smart device notification. The message may include an indication of an intruder status of the detected face, and/or an image of the detected face.

Referring to FIGS. 1, 2, and 5, and particularly FIG. 5, for the block diagram 500, the non-transitory computer readable medium 502 may include instructions 506 to detect, based on an analysis of a video stream, a face of a person in the video stream.

The processor 504 may fetch, decode, and execute the instructions 508 to compare the detected face to images of faces of people associated with an authorized user.

The processor 504 may fetch, decode, and execute the instructions 510 to analyze an emotion associated with the detected face.

The processor 504 may fetch, decode, and execute the instructions 512 to generate, based on the comparison of the detected face and the analysis of the emotion, a message to the authorized user via at least one of a phone call, an e-mail, a SMS, or a smart device notification. The message may include an indication of an intruder status of the detected face, and/or an image of the detected face.

The processor 504 may fetch, decode, and execute the instructions 514 to ascertain, from a monitoring tool, an alert related to operation of a device monitored by the monitoring tool or performance of a service monitored by the monitoring tool.

The processor 504 may fetch, decode, and execute the instructions 516 to generate, based on the alert, a support call that includes the phone call, the e-mail, the SMS, and/or the smart device notification to a support personnel.

The processor 504 may fetch, decode, and execute the instructions 518 to generate, based on an issue addressed in the alert, an incident ticket related to the alert.

The processor 504 may fetch, decode, and execute the instructions 520 to determine a resolution to the issue addressed in the alert.

The processor 504 may fetch, decode, and execute the instructions 522 to modify, based on the determined resolution to the issue addressed in the alert and a response to the support call from the support personnel, the incident ticket to include the resolution to the issue addressed in the alert.

The processor 504 may fetch, decode, and execute the instructions 524 to analyze a service level agreement related to the operation of the device monitored by the monitoring tool or the performance of the service monitored by the monitoring tool.

The processor 504 may fetch, decode, and execute the instructions 526 to generate, based on an analysis of the alert, the support call, the incident ticket, and the service level agreement, metrics related to the resolution to the issue addressed in the alert.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An artificial intelligence based service control and home monitoring apparatus comprising:
an alert analyzer, executed by at least one hardware processor, to
ascertain, from a monitoring tool, an alert related to operation of a device monitored by the monitoring tool or performance of a service monitored by the monitoring tool;
a support call generator, executed by the at least one hardware processor, to
generate, based on the alert, a support call that includes at least one of a phone call, an e-mail, a Short Message Service (SMS), or a smart device notification to a support personnel;
an incident ticket generator, executed by the at least one hardware processor, to
generate, based on an issue addressed in the alert, an incident ticket related to the alert;
an incident ticket modifier, executed by the at least one hardware processor, to
determine a resolution to the issue addressed in the alert, and
modify, based on the determined resolution to the issue addressed in the alert and a response to the support call from the support personnel, the incident ticket to include the resolution to the issue addressed in the alert; and
a metrics generator, executed by the at least one hardware processor, to
analyze a service level agreement related to the operation of the device monitored by the monitoring tool or the performance of the service monitored by the monitoring tool, and
generate, based on an analysis of the alert, the support call, the incident ticket, and the service level agreement, metrics related to the resolution to the issue addressed in the alert.

2. The artificial intelligence based service control and home monitoring apparatus according to claim 1, wherein the alert analyzer is executed by at least one hardware processor to ascertain, from the monitoring tool, the alert related to operation of the device monitored by the monitoring tool or performance of the service monitored by the monitoring tool by:
ascertaining the alert based on a determination by the monitoring tool that an alert signal level related to the operation of the device or the performance of the service exceeds a specified signal level threshold.

3. The artificial intelligence based service control and home monitoring apparatus according to claim 1, wherein the support call generator is executed by the at least one hardware processor to generate, based on the alert, the support call that includes at least one of the phone call, the e-mail, the SMS, or the smart device notification to the support personnel by:
determining a severity level for the alert from a plurality of severity levels;
determining, based on the severity level, whether the support call is to include the at least one of the phone call, the email, the SMS, or the smart device notification; and
generating, based on the alert and the determined severity level, the support call that includes the at least one of the phone call, the e-mail, the SMS, or the smart device notification to the support personnel.

4. The artificial intelligence based service control and home monitoring apparatus according to claim 1, wherein the support call generator is executed by the at least one hardware processor to generate, based on the alert, the support call that includes at least one of the phone call, the e-mail, the SMS, or the smart device notification to the support personnel by:
determining a severity level for the alert from a plurality of severity levels;
determining, based on the severity level, whether the support call is to specifically exclude the phone call, the email, the SMS, or the smart device notification; and
generating, based on the alert and the determined severity level, the support call that specifically excludes the phone call, the e-mail, the SMS, or the smart device notification to the support personnel.

5. The artificial intelligence based service control and home monitoring apparatus according to claim 1, wherein the support call generator is executed by the at least one hardware processor to generate, based on the alert, the support call that includes at least one of the phone call, the e-mail, the SMS, or the smart device notification to the support personnel by:
determining a severity level for the alert from a plurality of severity levels;
determining, based on the severity level, whether the support call is to include the at least one of the phone call, the email, the SMS, or the smart device notification;
determining, based on the severity level, a priority order of the at least one of the phone call, the email, the SMS, or the smart device notification; and
generating, based on the alert, the determined severity level, and the determined priority order, the support call that includes, according to the determined priority order, the at least one of the phone call, the e-mail, the SMS, or the smart device notification to the support personnel.

6. The artificial intelligence based service control and home monitoring apparatus according to claim 1, wherein the incident ticket modifier is executed by the at least one hardware processor to determine the resolution to the issue addressed in the alert by:
identifying, from a set of historical alerts, a plurality of alerts that are similar to the ascertained alert;
identifying an alert of the plurality of alerts that is most similar to the ascertained alert;
ascertaining a resolution for the most similar alert; and
utilizing the ascertained resolution for the most similar alert as the resolution to the issue addressed in the ascertained alert.

7. The artificial intelligence based service control and home monitoring apparatus according to claim 1, further comprising:
a video stream analyzer, executed by the at least one hardware processor, to
detect, based on an analysis of a video stream, a face of a person in the video stream;
a face analyzer, executed by the at least one hardware processor, to
compare the detected face to images of faces of people associated with an authorized user, and
analyze an emotion associated with the detected face; and
a message generator, executed by the at least one hardware processor, to
generate, based on the comparison of the detected face and the analysis of the emotion, a message to the authorized user via the at least one of the phone call, the e-mail, the SMS, or the smart device notification, wherein
the message includes at least one of an indication of an intruder status of the detected face, or
an image of the detected face.

8. The artificial intelligence based service control and home monitoring apparatus according to claim 7, wherein the face analyzer is executed by the at least one hardware processor to compare the detected face to images of faces of people associated with the authorized user by:
analyzing, for a social media website, a friend list associated with the authorized user; and
determining whether the detected face matches the images of faces of people in the friend list associated with the authorized user.

9. The artificial intelligence based service control and home monitoring apparatus according to claim 7, wherein the face analyzer is executed by the at least one hardware processor to compare the detected face to images of faces of people associated with the authorized user by:
analyzing a pre-specified list of people associated with the authorized user; and
determining whether the detected face matches the images of faces of the pre-specified list of people associated with the authorized user.

10. The artificial intelligence based service control and home monitoring apparatus according to claim 7, wherein the face analyzer is executed by the at least one hardware processor to analyze the emotion associated with the detected face, and the message generator is executed by the at least one hardware processor to generate, based on the comparison of the detected face and the analysis of the emotion, the message to the authorized user via the at least one of the phone call, the e-mail, the SMS, or the smart device notification by:
determining whether the emotion associated with the detected face matches a predetermined emotion of a plurality of predetermined emotions; and
based on a determination that the emotion associated with the detected face matches the predetermined emotion of the plurality of predetermined emotions, generating, based on the comparison of the detected face and the matched predetermined emotion, the message to the authorized user via the at least one of the phone call, the e-mail, the SMS, or the smart device notification that corresponds to the matched predetermined emotion.

11. The artificial intelligence based service control and home monitoring apparatus according to claim 7, wherein the message generator is executed by the at least one hardware processor to generate, based on the comparison of the detected face and the analysis of the emotion, the message to the authorized user via the at least one of the phone call, the e-mail, the SMS, or the smart device notification, and wherein the message includes the at least one of the indication of the intruder status of the detected face, or the image of the detected face, by:
determining, based on the comparison of the detected face to images of faces of people associated with the authorized user, whether the detected face matches an image of the images of faces of people associated with the authorized user;
determining, based on a determination that the detected face does not match any of the images of faces of people associated with the authorized user, that the detected face represents an intruder; and
generating the message to indicate the intruder status of the detected face.

12. A method for artificial intelligence based service control and home monitoring comprising:
detecting, by at least one hardware processor, based on an analysis of a video stream, a face of a person in the video stream;
comparing, by the at least one hardware processor, the detected face to images of faces of people associated with an authorized user;
analyzing, by the at least one hardware processor, an emotion associated with the detected face; and
generating, by the at least one hardware processor and based on the comparison of the detected face and the analysis of the emotion, a message to the authorized user via at least one of a phone call, an e-mail, a Short Message Service (SMS), or a smart device notification, wherein
the message includes at least one of
an indication of an intruder status of the detected face, or
an image of the detected face.

13. The method according to claim 12, wherein comparing, by the at least one hardware processor, the detected face to images of faces of people associated with the authorized user further comprises:
analyzing, by the at least one hardware processor and for a social media website, a friend list associated with the authorized user; and
determining, by the at least one hardware processor, whether the detected face matches the images of faces of people in the friend list associated with the authorized user.

14. The method according to claim 12, wherein comparing, by the at least one hardware processor, the detected face to images of faces of people associated with the authorized user further comprises:
analyzing, by the at least one hardware processor, a pre-specified list of people associated with the authorized user; and
determining, by the at least one hardware processor, whether the detected face matches the images of faces of the pre-specified list of people associated with the authorized user.

15. The method according to claim 12, wherein analyzing, by the at least one hardware processor, the emotion associated with the detected face, and generating, by the at least one hardware processor and based on the comparison of the detected face and the analysis of the emotion, the message to the authorized user via the at least one of the phone call, the e-mail, the SMS, or the smart device notification further comprises:
determining, by the at least one hardware processor, whether the emotion associated with the detected face matches a predetermined emotion of a plurality of predetermined emotions; and
based on a determination that the emotion associated with the detected face matches the predetermined emotion of the plurality of predetermined emotions, generating, by the at least one hardware processor and based on the comparison of the detected face and the matched predetermined emotion, the message to the authorized user via the at least one of the phone call, the e-mail, the SMS, or the smart device notification that corresponds to the matched predetermined emotion.

16. The method according to claim 12, wherein generating, by the at least one hardware processor and based on the comparison of the detected face and the analysis of the emotion, the message to the authorized user via the at least one of the phone call, the e-mail, the SMS, or the smart device notification, and wherein the message includes the at least one of the indication of the intruder status of the detected face, or the image of the detected face, further comprises:
determining, by the at least one hardware processor and based on the comparison of the detected face to images of faces of people associated with the authorized user, whether the detected face matches an image of the images of faces of people associated with the authorized user;
determining, by the at least one hardware processor and based on a determination that the detected face does not match any of the images of faces of people associated with the authorized user, that the detected face represents an intruder; and
generating, by the at least one hardware processor, the message to indicate the intruder status of the detected face.

17. The method according to claim 12, further comprising:
ascertaining, by the at least one hardware processor and from a monitoring tool, an alert related to operation of a device monitored by the monitoring tool or performance of a service monitored by the monitoring tool;
generating, by the at least one hardware processor and based on the alert, a support call that includes the at least one of the phone call, the e-mail, the SMS, or the smart device notification to a support personnel;
generating, by the at least one hardware processor and based on an issue addressed in the alert, an incident ticket related to the alert;
determining, by the at least one hardware processor, a resolution to the issue addressed in the alert;
modifying, by the at least one hardware processor and based on the determined resolution to the issue addressed in the alert and a response to the support call from the support personnel, the incident ticket to include the resolution to the issue addressed in the alert;
analyzing, by the at least one hardware processor, a service level agreement related to the operation of the device monitored by the monitoring tool or the performance of the service monitored by the monitoring tool; and
generating, by the at least one hardware processor and based on an analysis of the alert, the support call, the incident ticket, and the service level agreement, metrics related to the resolution to the issue addressed in the alert.

18. A non-transitory computer readable medium having stored thereon machine readable instructions, the machine readable instructions, when executed by at least one hardware processor, cause the at least one hardware processor to:
detect, based on an analysis of a video stream, a face of a person in the video stream;
compare the detected face to images of faces of people associated with an authorized user;
analyze an emotion associated with the detected face;
generate, based on the comparison of the detected face and the analysis of the emotion, a message to the authorized user via at least one of a phone call, an e-mail, a Short Message Service (SMS), or a smart device notification, wherein
the message includes at least one of
an indication of an intruder status of the detected face, or
an image of the detected face;
ascertain, from a monitoring tool, an alert related to operation of a device monitored by the monitoring tool or performance of a service monitored by the monitoring tool;
generate, based on the alert, a support call that includes the at least one of the phone call, the e-mail, the SMS, or the smart device notification to a support personnel;
generate, based on an issue addressed in the alert, an incident ticket related to the alert;
determine a resolution to the issue addressed in the alert;
modify, based on the determined resolution to the issue addressed in the alert and a response to the support call from the support personnel, the incident ticket to include the resolution to the issue addressed in the alert;
analyze a service level agreement related to the operation of the device monitored by the monitoring tool or the performance of the service monitored by the monitoring tool; and
generate, based on an analysis of the alert, the support call, the incident ticket, and the service level agreement, metrics related to the resolution to the issue addressed in the alert.

19. The non-transitory computer readable medium according to claim 18, wherein the machine readable instructions to compare the detected face to images of faces of people associated with the authorized user, when executed by at least one hardware processor, further cause the at least one hardware processor to:
analyze, for a social media website, a friend list associated with the authorized user; and
determine whether the detected face matches the images of faces of people in the friend list associated with the authorized user.

20. The non-transitory computer readable medium according to claim 18, wherein the machine readable instructions to ascertain, from the monitoring tool, the alert related to operation of the device monitored by the monitoring tool or performance of the service monitored by the monitoring tool, when executed by at least one hardware processor, further cause the at least one hardware processor to:
ascertain the alert based on a determination by the monitoring tool that an alert signal level related to the operation of the device or the performance of the service exceeds a specified signal level threshold.
